(19) United States
(12) Patent Application Publication
(10) Pub. No.: US 2021/0209484 A1
(43) Pub. Date: Jul. 8, 2021

(54) RELATING PRINT COVERAGE MATRICES TO OBJECT PROPERTY MATRICE

(71) Applicant: HEWLETT-PACKARD DEVELOPMENT COMPANY, L.P., Spring, TX (US)

(72) Inventors: Peter MOROVIC, Sant Cugat del Valles (ES); Jan MOROVIC, Essex (GB); Melanie M. GOTTWALS, Palo Alto, CA (US); Ingeborg TASTL, Palo Alto, CA (US)

(73) Assignee: HEWLETT-PACKARD DEVELOPMENT COMPANY, L.P., Houston, TX (US)

(21) Appl. No.: 16/075,629

(22) PCT Filed: Apr. 21, 2017
(86) PCT No.: PCT/US2017/028709

§ 371 Date: Aug. 4, 2018

(51) Int. Cl. G06N 5/04; B33Y 50/00; B29C 64/386; G06F 30/20; G06N 20/00

(52) U.S. Cl. CPC G06N 5/04; B33Y 50/00; G06F 2111/10; G06F 30/20; G06N 20/00; B29C 64/386

(57) ABSTRACT

In an example, a method includes receiving, at a processor, a first matrix comprising a set of print coverage vectors, each print coverage vector specifying print materials for object generation using additive manufacturing and a second matrix comprising a corresponding set of properties for objects generated using the print coverage vectors. The method may further include determining, by the processor, a solution to an objective function relating the first and second matrices.

### BACKGROUND

Three-dimensional objects generated by an additive manufacturing process may be formed in a layer-by-layer manner. In one example of additive manufacturing, an object is generated by solidifying portions of layers of build material. In examples, the build material may be in the form of a powder, liquid, or sheet material. In some systems, the intended solidification and/or physical properties may be achieved by printing an agent onto a layer of the build material. Energy may be applied to the layer and the build material on which an agent has been applied may coalesce and solidify. In other examples, chemical binding agents may be used to bind a build material. In other examples, three-dimensional objects may be generated by using extruded plastics or sprayed materials as build materials, which solidify to form an object.

Some printing processes that generate three-dimensional objects use data generated from a model of a three-dimensional object. This data may, for example, specify the locations at which to apply an agent to the build material, or where a build material itself may be placed, and the amounts to be placed. The data may be generated from a three-dimensional representation of an object to be printed.

### BRIEF DESCRIPTION OF DRAWINGS

Non-limiting examples will now be described with reference to the accompanying drawings, in which:

FIG. 1 is an example of a method of determining a mapping resource;

FIG. 2 is an example of a method for predicting a set of properties of a new print coverage vector;

FIGS. 3 and 4 are examples of processing circuitry; and

FIG. 5 is a simplified schematic of an example processor and an example machine readable medium.

### DETAILED DESCRIPTION

Some examples described herein provide an apparatus and a method for processing data relating to a three-dimensional object and/or for generating data that may be used, for example by a three-dimensional printing system, or in an object generation apparatus, to produce a three-dimensional object. In some examples, data describing three-dimensional content with a variety of specified object properties is processed. These object properties may comprise appearance properties (color, transparency, glossiness, etc.), or functional properties (for example, conductivity, density, porosity, strength, etc.), and different object portions may comprise different object properties.

In some examples herein, a three-dimensional object may be modelled in terms of ‘voxels’, i.e. three-dimensional pixels, wherein each voxel occupies or represents a discrete volume. In data modelling a three-dimensional object, a voxel at a given location may have at least one characteristic. For example, it may be empty, may have a particular color and/or may represent a particular material, or a particular object property, or the like. The voxels representing an object may have the same shape (for example, cubic or tetrahedral), or may differ in shape and/or size. A voxel may correspond to a region of a three-dimensional object which may be individually addressable volume in additive manufacturing. In some examples in which the intended solidification and/or physical properties may be achieved by printing an agent onto a layer of the build material to form a layer of an object. In some contexts, a voxel may be defined at the resolution to which an object model, an object, or object generation data, is defined.

In some examples, a print coverage vector defines print material data, for example detailing the amount of print materials (such as agent(s) to be deposited onto a layer of build material, or in some examples, build materials themselves), and, if applicable, their combinations. In some examples, this may be specified as a proportional volume coverage (for example, X % of a region of a layer of build material should have agent Y applied thereto). Such print materials may be related to or selected to provide at least one object property such as, for example, color, transparency, flexibility, elasticity, rigidity, surface roughness, porosity, conductivity, inter-layer strength, density, and the like.

An example of a print coverage vector is a print material volume coverage (Mvoc) vector. Such a vector may indicate that X % of a given region of a three-dimensional space should have a particular ‘material vector’ (Mvec) applied thereto, while other Mvecs are to be applied according to their own stated coverage proportion.

An Mvec may comprise any print agent, or a combination of print agents. In other words, Mvocs may specify not just individual print agents as Mvecs, but also combinations of print agents. For example, an Mvoc may specify that a proportion of voxels may have a first agent applied thereto, or a second agent, or a combination of the first and second agent, with a probability associated with each Mvec choice. An Mvoc vector may therefore have a plurality of values, wherein each value defines a proportion for a particular Mvec in an addressable location of the three-dimensional object. For example, in an object generation apparatus with two available print materials (for example, agents)—M1 and M2, where each print material may be independently deposited in an addressable area of a layer of the three-dimensional object, there may be 2² (i.e. four) proportions in a given Mvoc vector: a first proportion for M1 without M2; a second proportion for M2 without M1; a third proportion for an over-deposit (i.e. a combination) of M1 and M2, e.g. M2 deposited over M1 or vice versa; and a fourth proportion for an absence of both M1 and M2. In this case an Mvoc vector may comprise 4 Mvecs: [M1, M2, M1M2, Z] or with example values [0.2, 0.2, 0.5, 0.1]—i.e. over a region of a z slice, 20% of [x, y] locations receive M1 without M2, 20% of [x, y] locations receive M2 without M1, 50% of [x, y] locations receive M1 and M2 and 10% are left empty. As each value is a proportion and the set of values represent the available print material combinations, the set of values in each coverage vector sum to 1 or 100%.

This may be compared to another example of print coverage vector in which the proportional coverage is controlled but the at voxel' choices are not: i.e. a print coverage vector may specify that X % of a region receives agent M1 and Y % receives agent M2, but the overprinting of agents is not explicitly defined (although the sum of X and Y may be greater than 100, so overprinting may result). Such a print coverage vector may be termed a print agent vector herein.

The actual location at which each print material (for example, a drop of an agent) should be applied may be determined, for example, using halftoning techniques. A print coverage representation may provide the input for a halftoning process to generate control data that may be used by object generation apparatus to generate a three-dimensional object. For example, it may be determined that, to produce specified object properties, 25% of a layer of build material (or of a portion of a layer) should have an agent or Mvec applied thereto. The halftoning process determines where the drops of agent fall in order to provide 25% coverage, for example by comparing each location to a threshold value provided in a halftone threshold matrix.

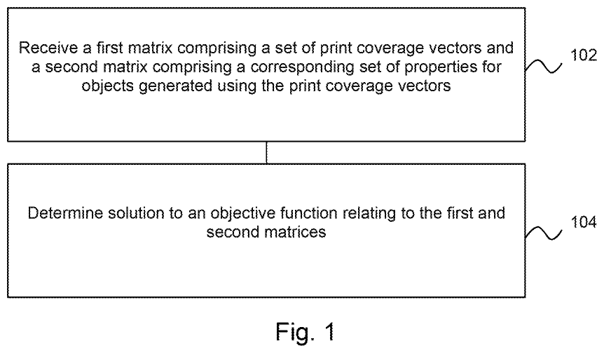

FIG. 1 is an example of a method, which may be a computer implemented method of determining a mapping resource.

Block 102 comprises receiving, at a processor, a first matrix comprising a set of print coverage vectors, each print coverage vector specifying print materials for object generation using additive manufacturing and a second matrix comprising a corresponding set of properties for objects generated print coverage vectors. The rows of the matrices may correspond, such that the first row of the first matrix comprises a first print coverage vector and the first row of the second matrix comprises the properties associated with an object generated using the first print coverage vector and so on. In other examples, the data may be organised in columns rather than rows.

In some examples, the print coverage vectors may comprise print agent vectors. In some examples, the print coverage vectors may comprise Mvocs in which explicit combinations and/or amounts of print agents are specified, or the like. The properties may comprise any set of properties, for example comprising at least one appearance property such as color and transparency, and/or mechanical and/or at least one functional property such as break strength, resilience, flexibility, elasticity, rigidity, surface roughness, porosity, conductivity, inter-layer strength, density, and the like.

In some examples, objects described by each print coverage vector of the set of print coverage vectors may be generated and analysed to determine their properties. Such objects may be generated using a particular print coverage vectors, and therefore different voxels may be generated using different print agents or Mvecs.

In some examples, the properties may comprise at least one ‘non-color’ or ‘non-appearance’ property, for example at least one functional property, for example conductivity, elasticity, strength, density, friction or the like. In some examples, the properties all comprise functional properties.

Block 104 comprises determining, by the processor, a solution to an objective function relating the first and second matrices.

A solution to an objective function is an optimisation of a stated relationship. For example, the solution to the objective function may be or comprise a mapping operator which maps between the first and second matrix with a minimum error.

By determining a solution to an objective function, that function can be used to predict the likely properties of a new print coverage vector and/or to predict a print coverage vector given intended properties. Such a method may be used in place of, for example, modelling or interpolation to predict properties, or in place of the manufacture of a large number of test objects to characterise the available properties.

As noted above, in some examples the set of print coverage vectors is a set of volumetric coverage agent vectors specifying at-voxel print agents and print agent combinations, for example in association with probabilities that such a state results (i.e. Mvocs). As the print agents to be applied to a voxel are explicit, such vectors may be more likely to perform as predicted, and result in less variable properties, which makes them particularly suited to prediction via an objective function.

Such a solution may be determined by processing circuitry, for example by a computer employing ‘supervised learning’ techniques.

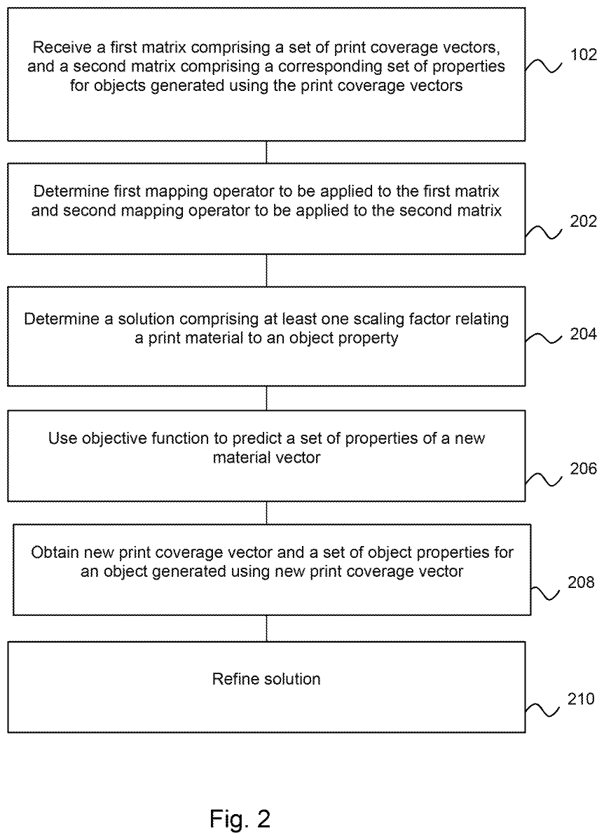

FIG. 2 is an example of a computer implemented method for predicting a set of properties of a new print coverage vector.

In this example, block 102 proceeds as in FIG. 1. Blocks 202-204 are an example of how a solution to an objective function may be determined.

Block 202 comprises determining a first mapping operator to be applied to the first matrix and a second mapping operator to be applied to the second matrix and block 204 comprises determining a solution comprising a transformation matrix.

For example, the objective function may be expressed as:
min_{T}∥g(T*f(M))−g(P)∥; where M is the first matrix and P is the second matrix, go and f( ) are mapping operators and T is a transformation matrix.

Determining the solution of the objective function may comprise determining T, f( ) and go, for example by treating the function as an L2 norm, or another “L norm” (such as an L1 norm or an L3 norm), or as a Frobenius norm, or some other matrix norm.

Functions f( ) and go allow for the mapping to be minimized between suitable adjusted representations of both the input print coverage vectors and the output vectors characterising the properties. Considering the example of Mvocs, f( ) may be configured to emphasis the influence of some Mvecs (for example, introducing a scaling factor, for example by raising some probabilities associated with print materials or print material combinations to a power), or may comprise a cross-product operator to introduce cross products between the Mvecs (i.e. agents or agent combinations) mentioned in an Mvoc or agents in a print agent vector.

To consider a set of N Mvoc print coverage vectors in a simple system using one powder and three agents A1, A2, A3 being printed in a binary fashion (i.e. an agent is applied or it is not), there are 2³=8 possible states for a single voxels: it may be left blank (B), have a single agent applied thereto (one of A1, A2 or A3), have a combination of 2 agents (A1A2, A1A3, A2A3), or have all three agents (A1A2A3). f( ) may be configured to result in terms such as A1² (i.e. raised to a power) or A1*A2 (a cross-product) could be introduced to the objective function.

In some examples, go could be used to perform linearization of raw property measurements. For example, CIE XYZ color measurements could be transformed to a more perceptually-uniform domain (e.g., CIE LAB, or CIECAM02) in which to minimize error. In some examples, g( ) may be 1. It may be noted that, in the above example, the operator g( ) is applied to both the first and second matrix, but this need not be the case in all examples.

The end result is a matrix T that, when applied to print coverage vectors transformed via a function f( ) makes a prediction of properties P (again transformed via a function—g()) such that the prediction minimizes the chosen metric (e.g. min_{T}∥g(T*f(M))−g(P)∥ (as set out above).

Block 206 comprises using the objective function to predict a set of properties of a new print coverage vector, wherein the new print coverage vector is not in the first matrix. This therefore predicts new properties for an ‘untested’ combination of materials. In other examples, the objective function may be used in the ‘other direction’, i.e. to predict one or more print coverage vectors which are likely to result in intended properties.

Block 208 comprises obtaining a new print coverage vector and a set of object properties for an object generated using new print coverage vector. The print coverage vector may be a new print coverage vector in the sense that it is not (or at least not previously) in the first matrix. This may for example comprise effectively adding a row or a column to the first and second matrix.

Block 210 comprises refining the determination of the solution based on the obtained print coverage vector and set of object properties.

In this way, the method may comprise a learning function. For example, this may be machine learning (e.g., supervised machine learning) and allows refinements of the solution to be made as more information becomes known. This in turn allows the solution to improve over time, meaning that more accurate predictions of the properties for new print coverage vectors may be made.

In some examples, the solution to an objective function may be specific to a particular object generation apparatus, or to a class or type of object generation apparatus. In some examples, the solution to an objective function may be specific to a predetermined set of materials.

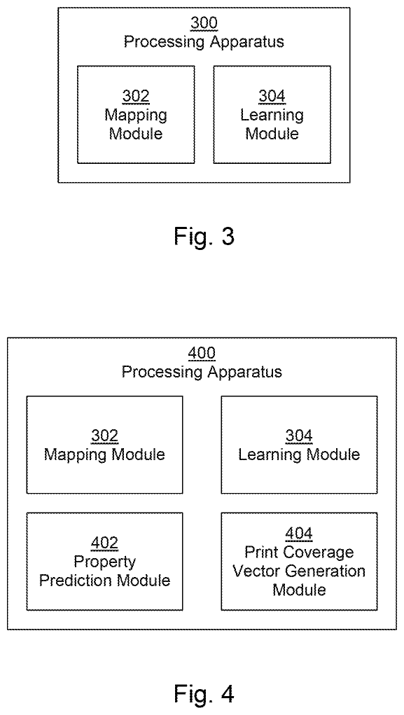

FIG. 3 is an example of processing apparatus 300 comprising a mapping module 302 and a learning module 304.

In use of the apparatus 300, the mapping module 302 estimates a solution to an objective function relating a set of print coverage vectors specifying print materials for object generation to a measured property or set of properties of an object generated using each print coverage vector and the learning module 304 adapts the solution based on a new print coverage vector and measured property. For example, the mapping module 302 may determine at least one transformation matrix and at least one mapping operator to be applied to a print coverage vector, for example as described in relation to FIGS. 1 and 2 above. The objective function may relate the vectors to a set of properties. The learning module 304 may allow the solution to become more refined over time, for example when more data sets comprising a print coverage vector and a property or property set are available.

FIG. 4 is another example of processing apparatus 400 comprising, in addition to the mapping module 302 and learning module 304 described above, a property prediction module 402 and a print coverage vector generation module 404.

The property prediction module 402 may, in use of the apparatus 400, predict an object property for a new print coverage vector, wherein the new print coverage vector is not in the set of print coverage vectors using the solution to the objective function. For example, the properties of an object to be generated using a particular print coverage vector, or combinations of print coverage vectors, may be predicted.

The print coverage vector generation module 404 may, in use of the apparatus 400, generate a new print coverage vector, wherein the new print coverage vector is not in the set of print coverage vectors, using solution to the objective function in response to an indication of intended object properties. In other words, the objective function may be used by the print coverage vector generation module 404 to generate a new print coverage vector which is predicted to have the intended object properties.

In one example, the object property or properties indicated may comprise any or any combination of a specification of a color, flexibility, elasticity, rigidity, surface roughness, porosity, inter-layer strength, density, conductivity and the like for at least a portion of the object to be generated. In some examples, the property or properties may comprise at least one functional or mechanical property. The specification of object properties may be by way of at least one value for the property (for example a density of x grams per unit volume, or a color specified using values of a color space).

As noted above, the objective function may be used to suggest one or more print coverage vectors which are likely to result in in a set of properties. In some examples, the objective function may be to predict a set of properties of a new print coverage vector, wherein the new print coverage vector is not in the first matrix. This therefore predicts new properties for an ‘untested’ combination of materials. In some cases, this may be verified through printing a test object and/or such a test object may be used to provide an input to the learning module 304 and thereby in adapting the solution.

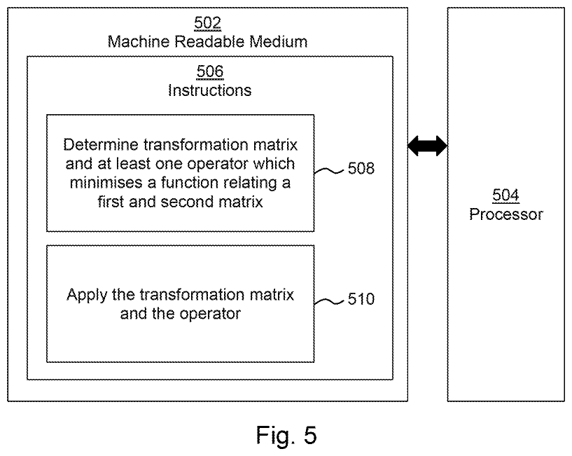

FIG. 5 is an example of a machine readable medium 502 in association with a processor 504. The machine readable medium 502 stores instructions 506 which, when executed by the processor 504, cause the processor 504 to carry out processing tasks. In this example, the instructions 506 comprise instructions 508 to cause the processor 504 to determine a transformation matrix and at least one operator which minimises a function relating a first and second matrix, wherein the first matrix comprises a set of print coverage vectors specifying print materials for object generation using additive manufacturing and the second matrix comprises a corresponding set of properties for objects generated using the print coverage vectors.

The instructions 506 further comprise instructions 510 to cause the processor 504 to apply the transformation matrix and the operator. For example, these may be applied to a new print coverage vector to estimate the properties thereof and/or to a set of properties to estimate a print coverage vector which, when used to generate the object, is predicted to result in the properties.

In some examples, the instructions 506 may further comprise instructions to cause the processor 504 to, on receipt of data adding a print coverage vector to the first matrix and a set of properties to the second matrix, re- determine at least one of the transformation matrix and the operator.

In some examples, the instructions 506 may be to cause the processor to carry out any of the blocks of the flow charts herein, or to provide a module of a processing apparatus 300, 400.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that at least some blocks in the flow charts and/or block diagrams, as well as combinations of the blocks in the flow charts and/or block diagrams, can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus (such as the processing apparatus 300, 400, or a module 302, 304, 402, 404 thereof or the processor 504 mentioned above) may execute the machine readable instructions. Thus the functional modules 302, 304, 402, 404 of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage (for example a machine readable 502 as described above) that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices may realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving, at a processor, a first matrix comprising a set of print coverage vectors, each print coverage vector specifying print materials for object generation using additive manufacturing and a second matrix comprising a corresponding set of properties for objects generated using the print coverage vectors; and
determining, by the processor, a solution to an objective function relating the first and second matrices.

2. A method according to claim 1 further comprising using the solution to predict a set of properties of a new print coverage vector, wherein the new print coverage vector is not in the first matrix.

3. A method according to claim 1 further comprising obtaining a new print coverage vector and a set of object properties for an object generated using new print coverage vector; and
refining the solution based on the obtained new print coverage vector and set of object properties.

4. A method according to claim 1 wherein determining the solution comprises determining a mapping operator to be applied to the first matrix.

5. A method according to claim 1 wherein determining solution comprises determining T, f( )and g( ) in a function: minT∥g(T*f(M))−g(P)∥, where M is the first matrix and P is the second matrix, f( ) and go are mapping operators and T is a transformation matrix.

6. A method according to claim 5 where the function to be minimised is an L2 norm.

7. A method according to claim 1 wherein the solution comprises at least one cross-product operator relating combinations of print materials to an object property.

8. A method according to claim 1 wherein solution comprises at least one scaling factor relating a print material to an object property.

9. A method according to claim 1 wherein the set of print coverage vectors is a set of volumetric coverage agent vectors specifying at-voxel print agents and print agent combinations.

10. Processing apparatus comprising:
a mapping module to estimate a solution to an objective function relating a set of print coverage vectors specifying print materials for object generation to a measured property of an object generated using each print coverage vector; and
a learning module, to adapt the solution based on a new print coverage vector and measured property.

11. Processing apparatus according to claim 10 further comprising:
a property prediction module to predict an object property for a new print coverage vector, wherein the new print coverage vector is not in the set of print coverage vectors, using the objective function.

12. Processing apparatus according to claim 10 further comprising:
a print coverage vector generation module to generate a new print coverage vector, wherein the new print coverage vector is not in the set of print coverage vectors, using the solution to the objective function in response to an indication of intended object properties.

13. Processing apparatus according to claim 10 where the mapping module is to determine at least one transformation matrix and at least one mapping operator to be applied to a print coverage vector.

14. A machine readable medium storing instructions which, when executed by a processor, cause the processor to:
determine a transformation matrix and at least one operator which minimise a function relating a first and second matrix, wherein the first matrix comprises a set of print coverage vectors specifying a print materials for object generation using additive manufacturing and the second matrix comprises a corresponding set of properties for objects generated using print coverage vectors; and
apply the transformation matrix and the operator to at least one of:
a new print coverage vector to estimate the properties of an object generated using the new print coverage vector; and
a set of properties to estimate a print coverage vector which, when used to generate the object, is predicted to result in the properties.

15. A machine readable medium storing instructions according to claim 14 which, when executed by a processor, cause the processor to, on receipt of data adding a print coverage vector to the first matrix and a set of properties to the second matrix, re-determine at least one of the transformation matrix and the operator.
